(19) United States
(12) Patent Application Publication
(10) Pub. No.: US 2023/0385137 A1
(43) Pub. Date: Nov. 30, 2023

(54) METHOD AND SYSTEM FOR SELF-MANAGING AND CONTROLLING MESSAGE QUEUES

(71) Applicant: Chaitanya Parkhi, Surrey (CA)

(72) Inventor: Chaitanya Parkhi, Surrey (CA)

(21) Appl. No.: 17/752,297

(22) Filed: May 24, 2022

(51) Int. Cl. G06F 9/54; G06F 9/50; G06F 9/30

(52) U.S. Cl. CPC G06F 9/546; G06F 9/505; G06F 9/3012

(57) ABSTRACT

Embodiments of the present disclosure disclose to a method and system for managing and controlling one or more message queues. The system includes at least one processor and a memory. The memory stores instructions which when executed by the at least one processor, cause the system to receive a plurality of messages from a plurality or recipients. The system creates one or more message queues for the one or more received messages. The system determines a set of ordering parameters. The system resets the one or more message queues based on the determined set of ordering parameters. The resetting of the one or more messages queues corresponds to auto-organizing the one or more messages in the one or more message queues. Furthermore, the system forwards the plurality of messages to a defined endpoint based on auto-organized order of the one or more messages in the one or more message queues.

### TECHNICAL FIELD

The present disclosure relates, generally, to the field of asynchronous messaging systems and more specifically to a new and useful method and system for managing and controlling message queues.

### BACKGROUND

Asynchronous messaging is a communication method where participants on both sides (sender side and receiver side) of the conversation have the freedom to start, pause, and resume conversational messaging on their own terms, eliminating the need for a direct live connection. Rather than waiting for an immediate response, a user can send a message and then continue with other unrelated tasks, while the responder can reply at a time that is convenient for him or her. Some examples of asynchronous messaging include text messaging, emailing, sending messages through social networking sites. Due to the vast number of users and objects in asynchronous communication systems, an administrator user or system responsible for managing requests and messages from these vast number of users can quickly become overwhelmed by a constant stream of incoming messages. In addition, messages may come from sources that are outside of these systems. Thus, it is difficult for the administrator user or system to determine which messages are important without identifying the source of the message or reading part of the message itself, such as the title or body of the message. Further, a user's mailbox may contain millions of lines of text in tens of thousands of messages collected over decades of use, making it even more difficult for the administrator user and their underlying system to distinguish relevant messages from non-relevant messages and sort them accordingly. Also, the users might face a long delay in responses or resolution as the messages are not well organized in the system.

Due to the above mentioned disadvantages, a need remains for a system and method for managing and controlling message queues to make the asynchronous communication systems efficient.

### SUMMARY OF THE INVENTION

Embodiments of the disclosed invention are related to a system for managing and controlling one or more message queues. The system includes at least one processor and a memory. The memory stores instructions which when executed by the at least one processor, cause the system to receive one or more messages from a plurality or recipients. In addition, the system creates one or more message queues for the one or more received messages. The system determines a set of ordering parameters. The set of ordering parameters are associated with the one or more messages. Further, the system resets the one or more message queues based on the determined set of ordering parameters. The resetting of the one or more messages queues corresponds to auto-organizing the one or more messages in the one or more message queues. Furthermore, the queuing system forwards the one or more messages to a defined endpoint based on auto-organized order of the one or more messages in the one or more message queues.

Embodiments of the disclosed invention are related to the one or more message queues that correspond to a list of one or more messages stored within a kernel. In addition, the one or more messages in the one or more message queues are identified by a unique identifier. The one or more message queues are created with definite destruction time.

Embodiments of the disclosed invention are related to the one or more message queues that are destroyed when a maximum capacity is reached. In addition, the one or more message queues are destroyed when time to live after maximum capacity is completed.

Embodiments of the disclosed invention are related to the one or more message queues that are created preemptively. The one or more message queues may be created dynamically.

Embodiments of the disclosed invention are related to the system that sends at least one of a success notification and an error notification to the defined endpoint. In addition, the success notification comprises at least one of: “preemptive queue created event payload”, “dynamic queue created”, “message received”, “message processed”, “maximum capacity reached”, and “queue destroyed”. In addition, the error notification includes at least one of “invalid message received”, “queue creations failed”.

Embodiments of the disclosed invention are related to the set of ordering parameters that are determined based on at least one of an ascending timestamp or a descending timestamp, and an importance level for a corresponding message from the one or more messages.

### BRIEF DESCRIPTION OF THE DRAWINGS

FIG. 1 illustrates a block diagram of a system, in accordance with an embodiment of the present disclosure;

FIG. 2 illustrates a flow chart depicting a method for self-managing and controlling one or more message queues, in accordance with an embodiment of the present disclosure;

FIG. 3 is a schematic diagram illustrating resetting of a message queue, in accordance with an embodiment of the present disclosure;

FIG. 4 is examplary architecture of a message queue, in accordance with an embodiment of the present disclosure;

FIG. 5 illustrates a use case for the system being integrated in railway reservation system, in accordance with an embodiment of the disclosure;

FIG. 6A illustrates a block diagram of format of a success notification sent to an endpoint from the system of FIG. 1, in accordance with an embodiment of the present disclosure;

FIG. 6B illustrates a block diagram of format of the success notification sent to an endpoint from the system of FIG. 1, in accordance with another embodiment of the present disclosure;

FIG. 6C illustrates a block diagram of format of the success notification sent to an endpoint from the system of FIG. 1, in accordance with yet another embodiment of the present disclosure;

FIG. 6D illustrates a block diagram of format of the success notification sent to an endpoint from the system of FIG. 1, in accordance with yet another embodiment of the present disclosure;

FIG. 6E illustrates a block diagram of format of the success notification sent to an endpoint from the system of FIG. 1, in accordance with yet another embodiment of the present disclosure; and

FIG. 7 is a schematic diagram illustrating internal components of the system, in accordance with an embodiment of the disclosure.

It should be noted that the accompanying figures are intended to present illustrations of a few examplary embodiments of the present disclosure. These figures are not intended to limit the scope of the present invention. It should also be noted that accompanying figures are not necessarily drawn to scale.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure.

As used in this specification and claims, the terms “for example”, “for instance”, and “such as”, and the verbs “comprising”, “having”, “including”, and their other verb forms, when used in conjunction with a listing of one or more components or other items, are each to be construed as open ended, meaning that that the listing is not to be considered as excluding other, additional components or items. The term “based on” means at least partially based on. Further, it is to be understood that the phraseology and terminology employed herein are for the purpose of the description and should not be regarded as limiting. Any heading utilized within this description is for convenience only and has no legal or limiting effect.

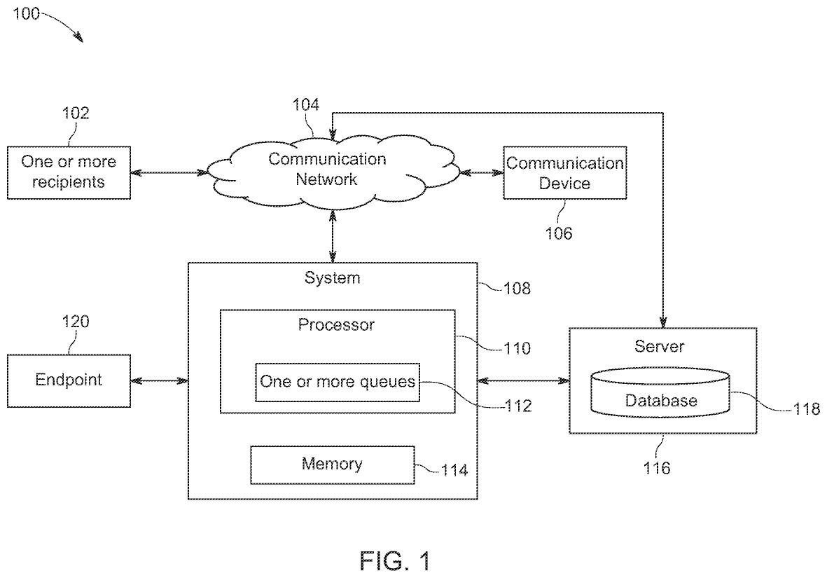

FIG. 1 illustrates a block diagram 100 of a system 108, in accordance with various embodiments of the present disclosure. The system 108 may specifically represent a queuing system in various embodiments, without deviating from the scope of the present disclosure. The block diagram 100 includes one or more recipients 102, a communication network 104, a communication device 106, the system 108, a server 116, a database 118 and an endpoint 120. In addition, the system 108 includes a processor 110 and a memory 114. The memory 114 stores instructions which are executed by the processor 110 to cause the system 108 perform a few steps for managing and controlling the one or more message queues 112.

The one or more recipients 102 send one or more messages to the system 108. The one or more recipients 102 send the one or more messages using a communication device 106. The one or more recipients may correspond to owner of the communication device 106. The one or more recipients 102 access the communication device 106 to send the one or more messages to the system 108. The communication device 106 includes but may not be limited to laptop, mobile phone, smartphone, desktop computer, personal digital assistant (PDA), palmtop, and tablet. The one or more recipients 102 send the one or more messages using the communication device 106 with facilitation of a communication network 104. The communication network 104 includes a satellite network, a telephone network, a data network (local area network, metropolitan network, and wide area network), distributed network, and the like. In one embodiment of the present invention, the communication network 104 is internet. In another embodiment of the present invention, the communication network 104 is a wireless mobile network. In yet another embodiment of the present invention, the communication network 104 is a combination of the wireless and wired network for optimum throughput of data extraction and transmission. The communication network 104 includes a set of channels. Each channel of the set of channels supports a finite bandwidth. The finite bandwidth of each channel of the set of channels is based on capacity of the communication network 104. In addition, the communication network 104 connects the system 108 to the server 116 and the database 118 using a plurality of methods. The plurality of methods used to provide network connectivity to the system 108 may include 2G, 3G, 4G, 5G, and the like.

The system 108 is communicatively connected with the server 116. In general, server is a computer program or device that provides functionality for other programs or devices. The server 116 provides various functionalities, such as sharing data or resources among multiple clients, or performing computation for a client. However, those skilled in the art would appreciate that the system 108 may be connected to a greater number of servers. Furthermore, it may be noted that the server 116 includes the database 118.

The server 116 handles each operation and task performed by the system 108. In one embodiment, the server 116 is located remotely. The server 116 is associated with an administrator. In addition, the administrator manages the different components associated with the system 108. The administrator is any person or individual who monitors the working of the system 108 and the server 116 in real-time. The administrator monitors the working of the system 108 and the server 118 through a computing device. The computing device includes laptop, desktop computer, tablet, a personal digital assistant, and the like. In addition, the database 118 stores data associated with the one or more recipients 102. The database 118 organizes the data using model such as relational models or hierarchical models. The database 118 also stores data provided by the administrator.

The system 108 receives the one or more messages from the plurality of recipients 102 in real-time. The processor 110 of the system 108 processes the one or more received messages and enables the system 108 to create the one or more message queues 112 for each of the one or more messages. The one or more message queues correspond to a list of the one or more messages stored within a kernel. In general, kernel is central component of an operating system that manages operations of computer and hardware. The one or more messages are identified by a unique identifier. Each of the one or more messages is labeled by the unique identifier (unique id) to distinguish between the one or more messages. The one or more message queues are created with definite destruction time. The definite destruction time is set based on one or more parameters. The one or more parameters are set at the time of queue creation. In addition, the definite destruction time is set during the queue creation. The one or more message queues 112 are destroyed when a maximum capacity is reached. The maximum capacity of the one or more message queues 112 is defined as no. of messages the one or more message queues 112 handles, balances and processes. The maximum capacity is provided during a queue creation process using field named “maxCapacity”. The one or more message queues 112 are destroyed when time to live after maximum capacity (TTLAMC) is completed. In an example, a message queue capacity reached at 9 AM UAT, and the TTLAMC is 1 hour. The message queue will be destroyed at 10 AM UAT. The one or more message queues 112 are auto-destroyed based on parameters such as TTL (time to live) and TTLAMC.

In one embodiment, the one or more message queues 112 are created preemptively. In general, preemptive queue is one which is created by the admin. In addition, ordering of messages is done based on criteria given at the time of queue creation. In another embodiment, the one or more message queues 112 are created dynamically. In general, a dynamic queue is a dynamic data structure that consists of a set of elements or messages that are placed sequentially one after another. In this case, the addition of elements or messages is carried out on one hand, and removal (stretching) of the elements or messages on the other hand.

Further, the system 108 determines a set of ordering parameters to organize the order of the one or more messages in the one or more message queues 112. The set of ordering parameters are associated with the one or more messages received from the plurality of recipients 102. The set of ordering parameters are determined based on ascending or descending timestamp of the one or more messages, importance of the one or more messages and the like. In an embodiment, the system 108 may receive a set of data associated with the one or more recipients 102 from the database 118 associated with the system 108. The set of data received from the database 118 is utilized to determine the set of ordering parameters.

The system 108 resets the one or more message queues 112 based on the determined set of ordering parameters. The resetting of the one or more message queues 112 corresponds to auto-organizing the one or more messages in the one or more message queues 112. Furthermore, the queuing system 108 forwards the one or more messages to a defined endpoint 120 based on the auto-organized order of the one or more messages in the one or more message queues 112. In an embodiment, the auto-organized order may correspond to an ascending timestamp order. In another embodiment, the auto-organized order may correspond to a descending timestamp order. In yet another embodiment, the auto-organized order may correspond to an importance level order. In yet another embodiment, the auto-organized order may not be limited to the above-mentioned orders. The endpoint 120 refers to sequential systems such as purchase order systems, reservation systems, and the like. In an embodiment, the one or more messages in the one or more message queues 112 are auto-organized using message schema and the set of ordering parameters. In an embodiment, the message schema defines the type of message payload a queue is going to process. If the inbound messages to a dynamic queue are not in compliance with the message schema, then the system 108 sends error notifications to the endpoint. In another embodiment, if inbound payload is compliant with the message schema, the queue is ordered by using the set of ordering parameters.

For example, three messages are received in a queue as mentioned below:
{“id”: 3, “data”: “This is data”, “country”: “Canada”}
{“id”: 2, “data”: “This is data”, “country”: “Belize”}
{“id”: 4, “data”: “This data”, “country”: “Zimbabwe”}

The three messages are received with the unique id. The queue is ordered in the below mentioned order:
{“id”: 2, data: “This is data”, “country”: “Belize”}
{“id”: 3, “data”: “This is data”, “country”: “Canada”}
{“id”: 4, “data”: “This is data”, “country”: “Zimbabwe”}

In another example, three messages are received in a queue with non-unique id as mentioned below:
{“id”: 3, “data”: “This is data”, “country”: “Canada”}
{“id”: 3. “data”: “This is data”, “country”: “Belize”}
{“id”: 4, “data”: “This is data”, “country”: “Zimbabwe”}

As the three messages are received with non-unique id, the queue orders the three messages based on next parameter (country) as ordering criteria as mentioned below:
{“id”: 3. “data”: “This is data”, “country”: “Belize”}
{“id”: 3, “data”: “This is data”, “country”: “Canada”}
{“id”: 4, “data”: “This is data”, “country”: “Zimbabwe”}

Also, the system 108 sends at least one of a success notification and an error notification to the defined endpoint 120. The success notification includes at least one of: “preemptive queue created event payload”, “dynamic queue created”, “message received”, “message processed”, “maximum capacity reached”, and “queue destroyed”. In addition, the error notification include at least one of “invalid message received”, and “queue creations failed” and the like. The system 108 sends all the data associated with the one or more messages to the endpoint 120 before the one or more message queues get empty or destroys. For “preemptive queue created event payload”, the notification includes all necessary details such as: “queue name”, “created by”, “Timestamp”, “maximum capacity”, “TTLAMC”, “Time to live”, “webhookurl”, “uniqueId” and response such as “Queue creation successful”. Webhookurl belongs to endpoint's web link. At the time of queue creation, if “TTLAMC” is less than “Time to live” the queue cannot be created.

For dynamic queue creation, the system 108 maintains registry of name of the one or more queues and the names are unique. The notification for dynamic queue creation includes all necessary details such as: “queue name”, “created by”, “Timestamp”, “maximum capacity”, “TTLAMC”, “Time to live”, “webhookurl”, “uniqueId” and response such as “Queue creation successful”. When the one or more message queues 112 gets destroyed, notification is sent to the endpoint 120 stating one or more destroy reasons. The one or more destroy reasons include but may not be limited to “Maximum capacity reached”, “TTLAMC reached”, “time to live reached”.

In an example, a dynamic or preemptive queue is created. The queue starts receiving one or more messages and compares inbound messages with message schema given to the queue at the time of the queue creation. If the message is in accordance with the message schema, the queue accepts that message and balances itself. In addition, if the message is not in accordance with the message schema, then the queue rejects the message and sends error notification to an endpoint (webhookurl). Further, the queue sends all the accumulated messages to the endpoint and gets empty after the maximum capacity is reached. Furthermore, the queue is destroyed after getting emptied. If the queue is not full by the time its “Time to live” is reached, the queue gets empties by sending all the accumulated messaged to the endpoint and destroys itself. Also, if the queue is full and there is “TTLAMC” specified, then the queue gets empty when “TTLAMC” is reached by sending all the messages to the endpoint and destroys itself.

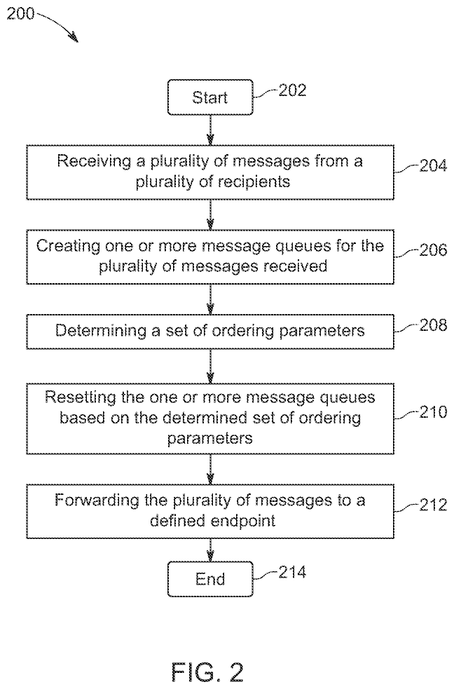

FIG. 2 illustrates a flow chart 200 depicting a method for managing and controlling one or more message queues 112 of FIG. 1, in accordance with an embodiment of the disclosure. The method is performed by the system 108 of FIG. 1.

The method initiates at step 202. Following step 202, at step 204, the method includes receiving a one or more messages form the plurality of recipients 102 in real time. The one or more recipients 102 send one or more messages to the queuing system 108. The one or more recipients 102 send the one or more messages using the communication device 106. The one or more recipients 102 correspond to owner of the communication device 106 in one embodiment. The one or more recipients 102 access the communication device 106 to send the one or more messages to the system 108.

At step 206, the method includes creating the one or more message queues 112 for the one or more messages received from the plurality of recipients 102. The one or more queues are created with definite destruction time. The one or more message queues 112 are destroyed when a maximum capacity is reached. The one or more message queues 112 are destroyed when time to live after maximum capacity (TTLAMC) is completed. In an example, a message queue capacity reached at 9 AM UAT, and the TTLAMC is 1 hour. The message queue will be destroyed at 10 AM UAT. Further, the one or more message queues 112 are created preemptively. In general, preemptive queue is one in which certain recipients are given a preemptive right to service over routine, and non-priority recipients. Servicing of the latter is thus liable to interruption by the arrival of a priority recipient. The priority recipient proceeds to head of the waiting line on arrival, but waits until service of the current recipient has ended. Furthermore, the one or more message queues 112 are created dynamically. In general, a dynamic queue is a dynamic data structure that consists of a set of elements or messages that are placed sequentially one after another. In this case, the addition of elements or messages is carried out on one hand, and removal (stretching) of the elements or messages on the other hand.

At step 208, the method includes determining a set of ordering parameters associated with the one or more messages. The set of ordering parameters are determined based on at least one of an ascending timestamp or a descending timestamp and an importance level for a corresponding message from the one or more messages and the like. In an embodiment, the system 108 may receive a set of data associated with the one or more recipients 102 from the database 118 connected with the system 108. The set of data received from the database 118 is utilized to determine the set of ordering parameters.

At step 210, the method includes resetting the one or more message queues 112 based on the determined set of ordering parameters. At step 212, the method includes forwarding the one or more messages to a defined endpoint 120. Also, the system 108 sends a success notification or an error notification to the defined endpoint 120. The success notification includes at least one of: “preemptive queue created event payload”, “dynamic queue created”, “message received”, “message processed”, “maximum capacity reached”, and “queue destroyed”. The error notification includes at least one of “invalid message received”, “queue creations failed” and the like. The system 108 sends all the data associated with the one or more messages to the endpoint 120 before the one or more message queues get empty or destroys. For “preemptive queue created event payload”, the notification includes all necessary details such as: “queue name”, “created by”, “Timestamp”, “maximum capacity”, “TTLAMC”, “Time to live”, “webhookurl”, “uniqueId” and response such as “Queue creation successful”. Webhookurl belongs to endpoint's web link.

The method terminates at step 214.

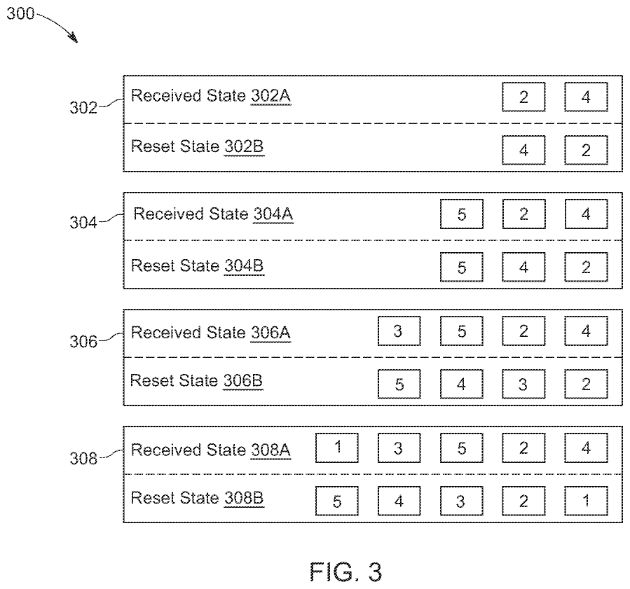

FIG. 3 is a schematic diagram 300 illustrating resetting of a message queue, in accordance with an embodiment of the disclosure. The schematic diagram 300 includes message queues 302, 304, 306, and 308. The message queue 302 includes a received state 302A of messages and a reset state 302B of messages. The messages are labeled with number “2” and “4”. In the received state 302A, the message with label “2” is stored first and the message with label “4” is stored later. In the reset state 302B, the order of the messages “2”, and “4” are reset in descending order. Hence, message “4” is stored first and message “2” is stored later.

The message queue 304 includes a received state 304A of messages and a reset state 304B of the messages. The messages are labeled with number “5”, “2” and “4”. In the received state 304A, the message with label “5” is stored first, the message with label “2” is stored after the message “5” and the message with label “4” is stored at the end. In the reset state 304B, the order of the messages “5”, “2”, and “4” are reset in descending order. Hence, the message “5” is stored first, the message “4” is stored after the message “5”, and the message “2” is stored at the end.

Similarly, the message queue 306 includes a received state 306A and a reset state 306B of messages. The messages are labeled with number “3”, “5”, “2” and “4”. In the received state 306A, the message with label “3” is stored first, the message with label “5” is stored after the message “3”, the message with label “2” is stored after message “5”, and the message with label “4” is stored at the end. In the reset state 306B, the order of the messages “3”, “5”, “2”, and “4” are reset in descending order. Hence, the message “5” is stored first, the message “4” is stored after the message “5”, the message “3” is stored after the message “4”, and the message “2” is stored at the end. The messages in the reset state 306B are in order: “5”, “4”, “3”, and “2”.

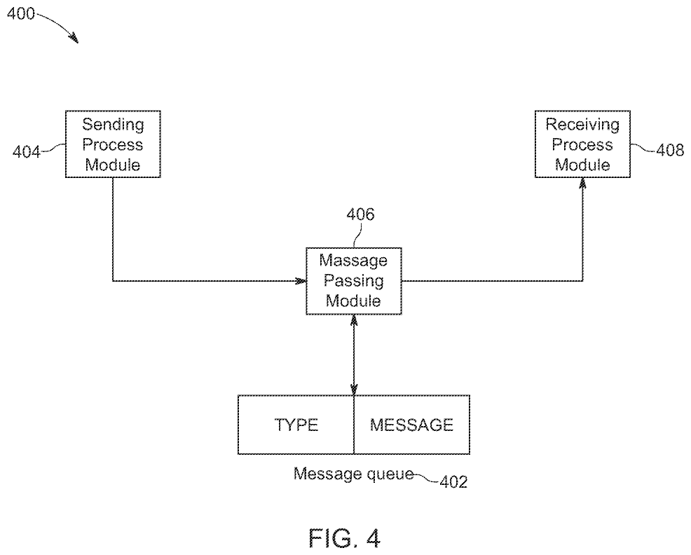

Similarly, the message queue 308 includes a received state 308A and a reset state 308B of messages. The messages are labeled with number “1”, “3”, “5”, “2” and “4”. In the received state 308A, the message with label “1” is stored first, the message with label “3” is stored after the message “1”, the message with label “5” is stored after the message “3”, the message with label “2” is stored after message “5”, and the message with label “4” is stored at the end. In the reset state 308B, the order of the messages “1”, “3”, “5”, “2”, and “4” are reset in descending order. Hence, the message “5” is stored first, the message “4” is stored after the message “5”, the message “3” is stored after the message “4”, the message “2” is stored after the message “3”, and the message “1” is stored at the end. The messages in the reset state 308B are in order: “5”, “4”, “3”, “2”, and “1”. The order of the messages in the reset state is not fixed and may vary. FIG. 4 is examplary architecture 400 of a message queue 402, in accordance with an embodiment of the present disclosure. The architecture 400 includes a sending process module 404, a message passing module 406, and a receiving process module 408. The sending process module 404 and the receiving process module 408 can exchange information through access to the message queue 402. The sending process module 404 places a message through the message-passing module 406 onto the message queue 402 that is read by the receiving process module 408. Each message is given an identification or type so that the sending process module 404 and the receiving process module 408 may select appropriate message. The message queue 402 may be managed and controlled using one or more system calls using the queuing system 108 of FIG. 1. The one or more system calls includes but may not be limited to:
1. ftok( ): It is use to generate a unique key.
2. msgget( ): It either returns the unique identifier for a newly created message queue or returns the identifiers for a queue which exists with the same key value.
3. msgsnd( ) Data is placed on to the message queue 402 by calling msgsnd( )
4. msgrcv( ) messages are retrieved from a queue.
5. msgctl( ) It performs various operations on a queue. Generally it is use to destroy message queue.

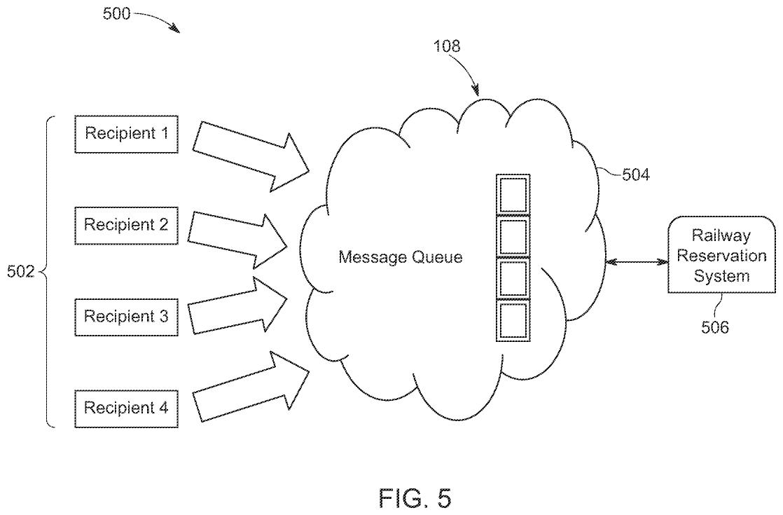

FIG. 5 illustrates a use case 500 for the queuing system 108 of FIG. 1 being integrated with a railway reservation system 506, in accordance with an embodiment of the disclosure. The use case 500 includes a plurality of recipients 502, a message queue 504, and the railway reservation system 506. The plurality of recipients 502 corresponds to passengers who travel frequently through a particular train. The plurality of recipients 502 includes recipient 1, recipient 2, recipient 3, recipient 4 and recipient 5.

Now, recipient 1 has sent a message request for an invoice of its fare tickets of last 3 months. Recipient 2 has sent a message request for an invoice of its fare tickets of last 15 days. Recipient 3 has sent a message request for an invoice of its fare tickets of last 1 month. Recipient 4 has sent a message request for an invoice of its fare tickets of last 7 days. Recipient 5 has sent a message request for an invoice of its fare tickets of last 5 months. The message queue 504 stores all the message requests in first come first serve order. The queuing system 108 resets the message queue 504 in ascending order of timespan of fare tickets (7 days, 15 days, 1 month, 3 months and 5 months). The message queue 504 is reset such that message request of recipient 4 is stored first, then message request of recipient 2 is stored. After that, message request of recipient 3 is stored, and then message request of recipient 1 is stored. The message request of recipient 5 is stored at the end. Further, the railway reservation system 506 provides invoices to the plurality of recipients 502 based on reset message queue. Recipient 4 receives the invoice at the earliest. After that, recipient 2 receives the invoice. Then, recipient 3 receives the invoice after recipient 2. After that, recipient 1 receives the invoice and at last recipient 5 receives the invoice.

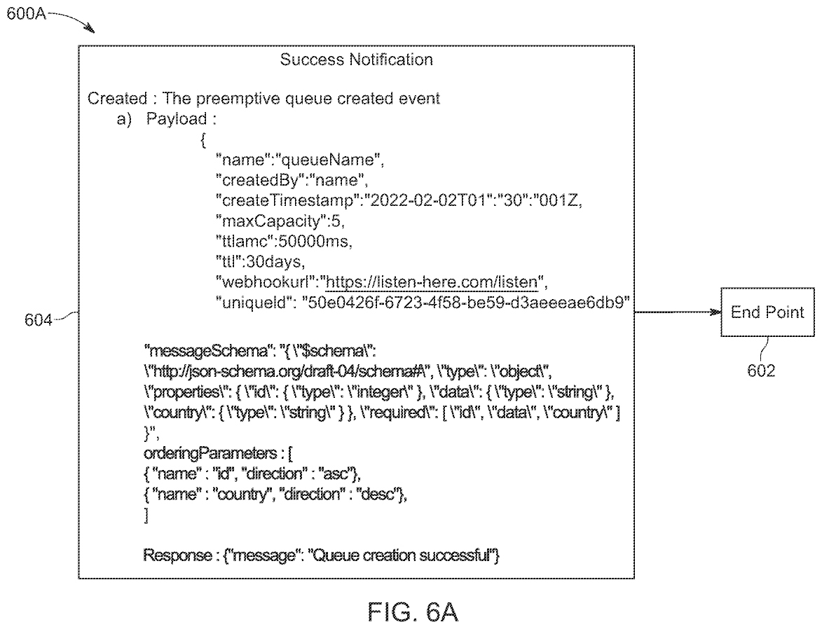

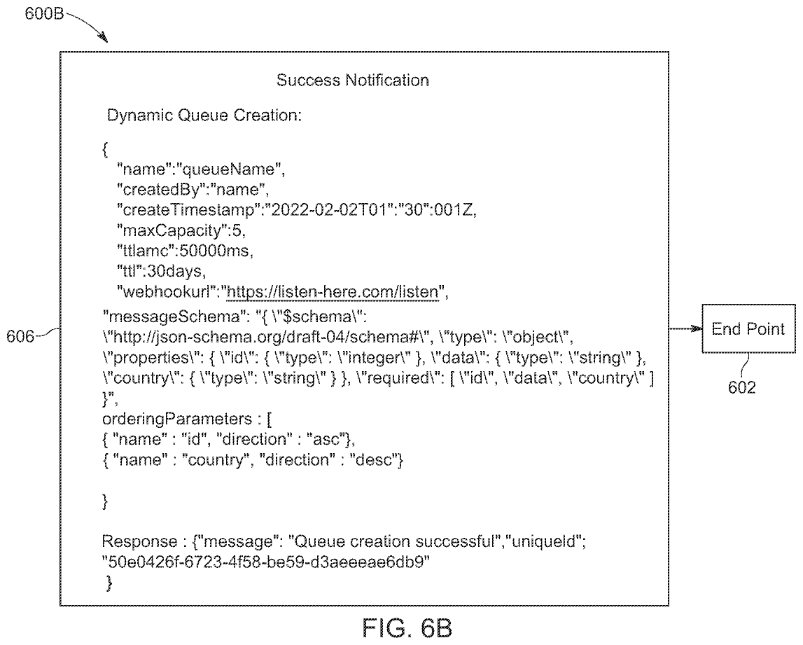

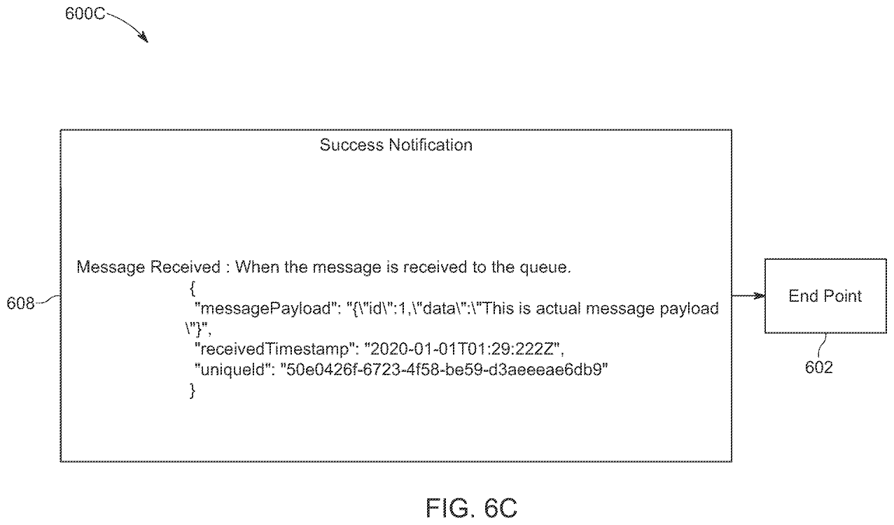

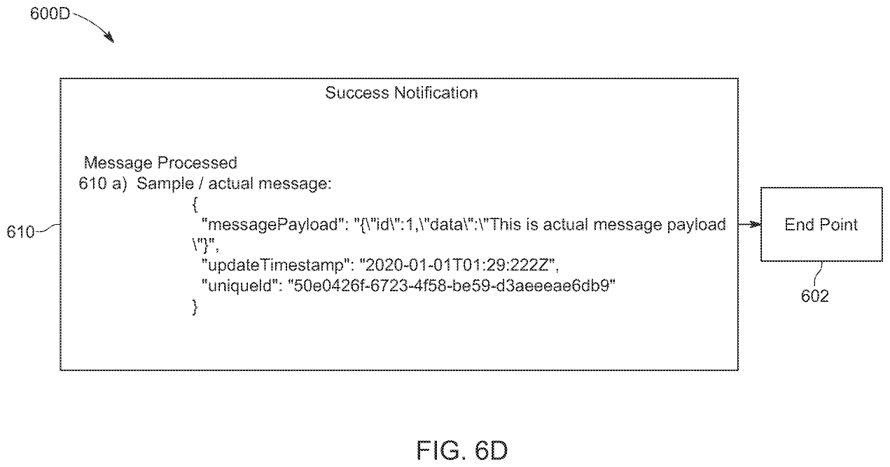

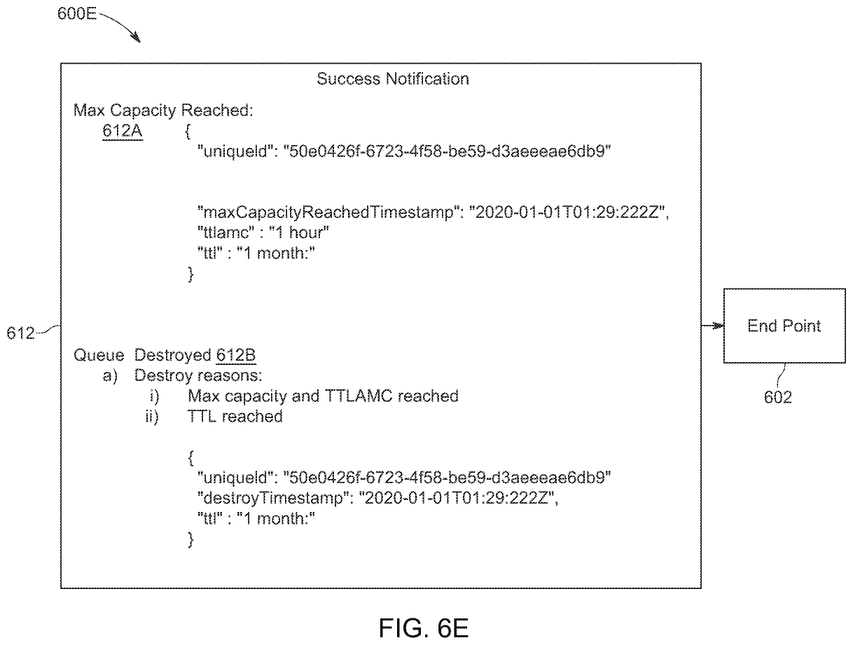

FIG. 6A illustrates block diagram 600A of format of a success notification 604 sent to an endpoint 602 from the system 108 of FIG. 1, in accordance with an embodiment of the present disclosure. The block diagram 600A includes the success notification 604 and the endpoint 602. The endpoint receives the success notification 604 from the system 108. The success notification 604 corresponds to a notification for preemptive queue creation payload. In preemptive queue creation, a user provides the unique Id to the system 108. The success notification 604 includes all necessary details such as: “queue name”, “created by”, “Timestamp”, “maxCapacity”, “TTLAMC”, “ttl”, “ttlamc”, “webhookurl”, “uniqueId” and response such as “Queue creation successful”. Webhookurl belongs to endpoint's web link. The “maxCapacity” is the maximum capacity of the queue, “ttl” is time to live and “ttlamc” is time to live after max capacity reached. The “maxCapacity”, “ttl”, and “ttlamc” are configurations that are API (Application Program Interface) driven.

FIG. 6B illustrates a block diagram 600B of format of a success notification 606 sent to the endpoint 602 from the system 108 of FIG. 1, in accordance with an embodiment of the present disclosure. The block diagram 600B includes the success notification 606 and the endpoint 602. The success notification 606 corresponds to notification for dynamic queue creation and a message with schema. For dynamic queue creation, the system 108 maintains registry of name of the one or more queues and the names are unique. The success notification 606 for dynamic queue creation includes all necessary details such as: “queue name”, “created by”, “Timestamp”, “maximum capacity”, “TTLAMC”, “Time to live”, “webhookurl”, “uniqueId” and response such as “Queue creation successful”. In dynamic queue creation, the unique id is generated by the system 108 and is returned in response payload. The message with schema includes all necessary details related to message schema such as type, object, properties, and requirements of the message along with timestamp and unique id.

FIG. 6C illustrates a block diagram 600C of format of a success notification 608 sent to the endpoint 602 from the system 108 of FIG. 1, in accordance with an embodiment of the present disclosure. The success notification 608 corresponds to a notification for message received. The success notification 608 includes all necessary details for the message being received to the queue along with the timestamp and unique id.

FIG. 6D illustrates a block diagram 600D of format of a success notification 610 sent to the endpoint 602 from the system 108 of FIG. 1, in accordance with an embodiment of the present disclosure. The success notification 610 corresponds to a message processed notification 610a. The message processed notification 610a includes all necessary details corresponding to a sample or actual message such as message payload, timestamp, unique id and the like.

FIG. 6E illustrates a block diagram 600E of format of a success notification 612 sent to the endpoint 602 from the system 108 of FIG. 1, in accordance with an embodiment of the present disclosure. The success notification 612 corresponds to a notification 612A for maximum capacity reached. The notification 612A includes all necessary details of a message queue such as maximum capacity reached timestamp, time to live and the like. In addition, the success notification 612 corresponds to a notification 612B for queue destroyed. The notification 612B includes destroy reasons for the queue. The destroy reasons includes but may not be limited to i.) Maximum capacity and TTLAMC reached and ii.) Time to live reached.

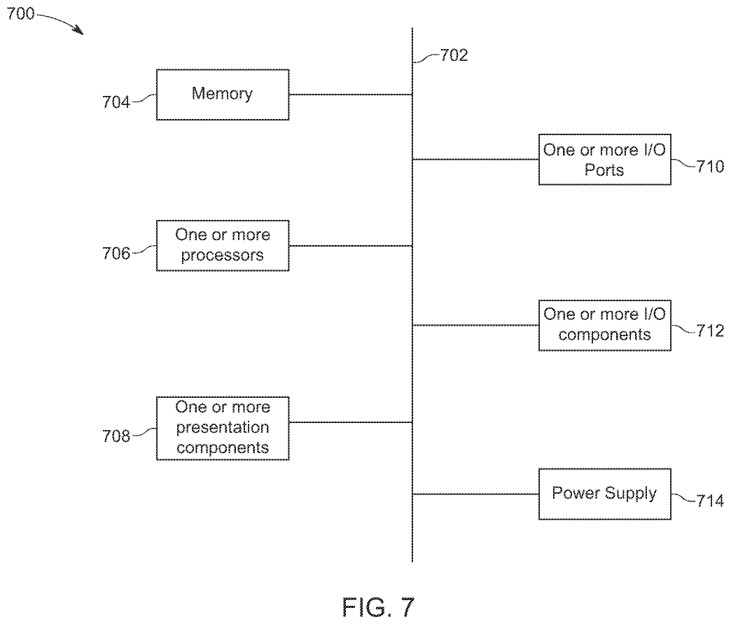

FIG. 7 illustrates a block diagram illustrating internal components of a system 700, in accordance with various embodiments of the present disclosure. The queuing system 700 corresponds to the system 108 of FIG. 1. The internal components of the queuing system 700 includes a bus 702 that directly or indirectly couples the following devices: memory 704, one or more processors 706, one or more presentation components 708, one or more input/output (I/O) ports 710, one or more input/output components 712, and an illustrative power supply 714. The bus 702 represents what may be one or more busses (such as an address bus, data bus, or combination thereof). Although the various blocks of FIG. 7 are shown with lines for the sake of clarity, in reality, delineating various components is not so clear, and metaphorically, the lines would more accurately be grey and fuzzy. For example, one may consider a presentation component such as a display device to be an I/O component. It may be understood that the diagram of FIG. 7 is merely illustrative of an exemplary queuing system 108 that can be used in connection with one or more embodiments of the present invention. The distinction is not made between such categories as “workstation,” “server,” “laptop,” “hand-held device,” etc., as all are contemplated within the scope of FIG. 7 and reference to “a system or queuing system.”

The system 700 typically includes a variety of computer-readable media. The computer-readable media can be any available media that can be accessed by the system 700 and includes both volatile and nonvolatile media, removable and non-removable media. By way of example, and not limitation, the computer-readable media may comprise computer readable storage media and communication media. The computer readable storage media includes volatile and nonvolatile, removable and non-removable media implemented in any method or technology for storage of information such as computer-readable instructions, data structures, program modules or other data.

The computer-readable storage media with memory 704 includes, but is not limited to, non-transitory computer readable media that stores program code and/or data for longer periods of time such as secondary or persistent long term storage, like RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the communication device 700. The computer-readable storage media associated with the memory 704 and/or other computer-readable media described herein can be considered computer readable storage media for example, or a tangible storage device. The communication media typically embodies computer-readable instructions, data structures, program modules or other data in a modulated data signal such as a carrier wave or other transport mechanism and in such a includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media. The system 700 includes one or more processors that read data from various entities such as the memory 704 or I/O components 712. The one or more presentation components 708 present data indications to a user or other device. Exemplary presentation components include a display device, speaker, printing component, vibrating component, etc. The one or more I/O ports 710 allow the queuing system 700 to be logically coupled to other devices including the one or more I/O components 712, some of which may be built in. Illustrative components include a microphone, joystick, game pad, satellite dish, scanner, printer, wireless device, etc.

The above-described embodiments of the present disclosure may be implemented in any of numerous ways. For example, the embodiments may be implemented using hardware, software or a combination thereof. When implemented in software, the software code may be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Also, the embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments. Therefore, it is the object of the appended claims to cover all such variations and modifications as come within the true spirit and scope of the present disclosure.

Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

We claim:

1. A system for managing one or more messages, the system comprising: at least one processor; and a memory having instructions stored thereon that, when executed by the at least one processor, cause the system to:
receive the one or more messages from one or more recipients;
create one or more message queues for the one or more received messages;
determine a set of ordering parameters, wherein the set of ordering parameters are associated with the one or more messages;
reset the one or more message queues based on the determined set of ordering parameters, wherein resetting the one or more message queues corresponds to auto-organizing each of the one or more messages in the one or more message queues; and
forward the one or more messages to a defined endpoint based on the auto-organized order of the one or more messages in the one or more message queues.

2. The system of claim 1, wherein the one or more message queues correspond to a list of the one or more messages stored within a kernel, wherein the one or more messages in the one or more message queues are identified by a unique identifier, wherein the one or more message queues are created with a definite destruction time.

3. The system of claim 1, wherein the one or more message queues are destroyed when a maximum capacity is reached.

4. The system of claim 1, wherein the one or more message queues are destroyed when time to live after maximum capacity is completed.

5. The system of claim 1, wherein the one or more message queues are created preemptively.

6. The system of claim 1, wherein the one or more message queues are created dynamically.

7. The system of claim 1, wherein the system sends at least one of a success notification and an error notification to the defined endpoint, wherein the success notification comprises at least one of: “preemptive queue created event payload”, “dynamic queue created”, “message received”, “message processed”, “maximum capacity reached”, and “queue destroyed”, wherein the error notification comprises at least one of “invalid message received”, and “queue creation failed”.

8. The system of claim 1, wherein the set of ordering parameters are determined based on at least one of an ascending timestamp or a descending timestamp and an importance level for a corresponding message from the one or more messages.

9. A computer implemented method for managing and controlling message queues, the method comprising:
receiving one or more messages from a plurality of recipients;
creating one or more message queues for the one or more received messages;
determining a set of ordering parameters, wherein the set of ordering parameters are associated with the one or more messages;
resetting the one or more message queues based on the determined set of ordering parameters, wherein resetting the one or more message queues corresponds to auto-organizing the one or more messages in the one or more message queues; and
forwarding the one or more messages to a defined endpoint based on auto-organized order of the one or more messages in the one or more message queues.

10. The method of claim 8, wherein the one or more queues are created with definite destruction time.

11. The method of claim 8, wherein the one or more queues are destroyed when a maximum capacity is reached.

12. The method of claim 8, wherein the one or more queues destroys when time to live after maximum capacity is completed.

13. The method of claim 8, wherein the one or more queues are created preemptively, wherein the one or more queues are created dynamically.

14. The method of claim 8, further comprising:
sending a success notification and an error notification to the defined endpoint, wherein the success notification comprises at least one of: “preemptive queue created event payload”, “dynamic queue created”, “message received”, “message processed”, “maximum capacity reached”, and “queue destroyed”, wherein the error notification comprises at least one of “invalid message received”, and “queue creations failed”.

15. The method of claim 8, wherein the set of ordering parameters are determined based on at least one of an ascending timestamp or a descending timestamp, and importance level for a corresponding message from the one or more messages.
